(19) United States
(12) Patent Application Publication
(10) Pub. No.: US 2015/0066384 A1
(43) Pub. Date: Mar. 5, 2015

(54) SYSTEM AND METHOD FOR ALIGNING GENOME SEQUENCE

(71) Applicant: SAMSUNG SDS CO., LTD., Seoul (KR)

(72) Inventor: Min Seo PARK, Seoul (KR)

(73) Assignee: SAMSUNG SDS CO., LTD., Seoul (KR)

(21) Appl. No.: 14/273,205

(22) Filed: May 8, 2014

(30) Foreign Application Priority Data
Sep. 3, 2013 (KR) 10-2013-0105529

(51) Int. Cl. G06F 19/22

(52) U.S. Cl. CPC G06F 19/22
USPC 702/20

(57) ABSTRACT

Provided are a system and method for sequence alignment. The system for sequence alignment includes an exact matching module configured to perform exact matching of an input read to a reference sequence, a secondary matching module configured to map the read to the reference sequence in consideration of mismatches between the read and the reference sequence when the read does not exactly match the reference sequence, and a global alignment module configured to perform global alignment operation of the read with the reference sequence when the read is not mapped to the reference sequence by the secondary matching module.

### CROSS-REFERENCE TO RELATED APPLICATION

This application claims priority to and the benefit of Korean Patent Application No. 10-2013-0105529, filed on Sep. 3, 2013, the disclosure of which is incorporated herein by reference in its entirety.

### BACKGROUND

1. Field

The present disclosure relates to technology for analysis of a genome sequence, and more particularly, to a system and method for sequence alignment.

2. Discussion of Related Art

Due to low cost and rapid data generation, Next-Generation Sequencing (NGS) for generation of massive short sequences is rapidly replacing traditional Sanger sequencing. Also, various NGS alignment programs have been developed with a focus on accuracy.

The first step of resequencing is to map a read to an accurate position in a reference sequence by using a sequence alignment algorithm. To this end, an existing general sequence alignment algorithm is configured so that a seed of a predetermined length selected from the read is first mapped to the reference sequence, and a remaining read is subjected to global alignment at the mapped position.

This existing sequence alignment algorithm involves performing global alignment at all candidate positions in a reference sequence obtained by using a seed. However, global alignment has a complexity of O(N²) and is an operation requiring a very long time to execute.

Therefore, according to related art, a sequence alignment time exponentially increases, particularly, when the number of candidate positions increase.

### SUMMARY

Embodiments of the present disclosure are directed to providing a means for effectively reducing, during sequence alignment using a read input from a sequencer, the number of times of performing global alignment which requires a very long time to execute and much processing power.

According to an aspect of the present disclosure, there is provided a system for sequence alignment including: an exact matching module configured to perform exact matching of an input read to a reference sequence; a secondary matching module configured to map the read to the reference sequence in consideration of mismatches between the read and the reference sequence when the read does not exactly match the reference sequence; and a global alignment module configured to perform global alignment of the read with the reference sequence when the read is not mapped to the reference sequence by the secondary matching module.

The system for sequence alignment may further include a seed generation module configured to generate a plurality of seeds from the read when the read does not exactly match the reference sequence.

The seed generation module may generate the plurality of seeds from entire sections of the read.

The seed generation module may generate the plurality of seeds by reading values of portions of the read as large as a set size while shifting by a set distance from a first base of the read.

The seed generation module may generate the plurality of seeds to have a length of 15 base pairs (bps) to 30 bps.

The secondary matching module may calculate mapping positions of the generated seeds in the reference sequence, and determine a mapping position of the read in the reference sequence in consideration of mismatches occurring when exact matching of the read to the reference sequence is attempted at each of the mapping positions of the seeds.

The secondary matching module may determine a position resulting in a minimum number of mismatches among the mapping positions of the seeds as the mapping position of the read.

The secondary matching module may determine a position resulting in a minimum sum of quality scores (QSs) of mismatches among the mapping positions of the seeds as the mapping position of the read.

The secondary matching module may determine a position resulting in a number of mismatches equal to or smaller than a set value and a minimum sum of QSs of the mismatches among the mapping positions of the seeds as the mapping position of the read.

The global alignment module may perform global alignment operation of the read with the reference sequence at each of the mapping positions of the seeds.

The global alignment module may sequentially perform the global alignment operation beginning at a mapping position resulting in a minimum sum of QSs of mismatches among the mapping positions of the seeds.

The global alignment module may sequentially perform the global alignment operation beginning at a mapping position resulting in a minimum sum of a number of mismatches and a number of gaps equal to or smaller than a set value among the mapping positions of the seeds.

The global alignment module may sequentially perform the global alignment operation beginning at a mapping position resulting in a sum of a number of mismatches and a number of gaps equal to or smaller than a set value and a minimum sum of QSs of the mismatches and the gaps among the mapping positions of the seeds.

According to another aspect of the present disclosure, there is provided a method for sequence alignment including: an exact matching step of performing, at an exact matching module, exact matching of an input read to a reference sequence; a secondary matching step of mapping, at a secondary matching module, the read to the reference sequence in consideration of mismatches between the read and the reference sequence when the read does not exactly match the reference sequence; and a global alignment operation step of performing, at a global alignment module, global alignment operation of the read with the reference sequence when the read is not mapped to the reference sequence in the secondary matching step.

The method for sequence alignment may further include, before the secondary matching step, a seed generation step of generating a plurality of seeds from the read when the read does not exactly match the reference sequence.

The seed generation step may include generating the plurality of seeds from entire sections of the read.

The seed generation step may include generating the plurality of seeds by reading values of portions of the read as large as a set size while shifting by a set distance from a first base of the read.

The seed generation step may include generating the plurality of seeds to have a length of 15 bps to 30 bps.

The secondary matching step may include: calculating mapping positions of the generated seeds in the reference sequence; and determining a mapping position of the read in the reference sequence in consideration of mismatches occurring when exact matching of the read to the reference sequence is attempted at each of the mapping positions of the seeds.

The determination of the mapping position may include determining a position resulting in a minimum number of mismatches among the mapping positions of the seeds as the mapping position of the read.

The determination of the mapping position may include determining a position resulting in a minimum sum of QSs of mismatches among the mapping positions of the seeds as the mapping position of the read.

The determination of the mapping position may include determining a position resulting in a number of mismatches equal to or smaller than a set value and a minimum sum of QSs of the mismatches among the mapping positions of the seeds as the mapping position of the read.

The global alignment step may include performing global alignment operation of the read with the reference sequence at each of the mapping positions of the seeds.

The global alignment step may include sequentially performing the global alignment operation beginning at a mapping position resulting in a minimum sum of QSs of mismatches among the mapping positions of the seeds.

The global alignment step may include sequentially performing the global alignment operation beginning at a mapping position resulting in a minimum sum of a number of mismatches and a number of gaps equal to or smaller than a set value among the mapping positions of the seeds.

The global alignment step may include sequentially performing the global alignment operation beginning at a mapping position resulting in a sum of a number of mismatches and a number of gaps equal to or smaller than a set value and a minimum sum of QSs of the mismatches and the gaps among the mapping positions of the seeds.

### BRIEF DESCRIPTION OF THE DRAWINGS

The above and other objects, features, and advantages of the present disclosure will become more apparent to those of ordinary skill in the art by describing in detail exemplary embodiments thereof with reference to the accompanying drawings, in which:

FIG. 1 is a flowchart illustrating a method for sequence alignment according to an exemplary embodiment of the present disclosure;

FIGS. 2A-2E show diagrams exemplifying a minimum Error Bound (mEB) calculation process in the method for sequence alignment according to the exemplary embodiment of the present disclosure;

FIGS. 3 to 5 are diagrams exemplifying a seed generation process according to exemplary embodiments of the present disclosure;

FIG. 6 is a diagram exemplifying mismatches in a case of attempting exact matching of a read to a reference sequence according to an exemplary embodiment of the present disclosure;

FIG. 7 is a diagram exemplifying a secondary matching process according to an exemplary embodiment of the present disclosure; and

FIG. 8 is a block diagram of a system for sequence alignment according to an exemplary embodiment of the present disclosure.

### DETAILED DESCRIPTION OF EXEMPLARY EMBODIMENTS

Hereinafter, exemplary embodiments will be described more fully with reference to the accompanying drawings to clarify aspects, features, and advantages of the present disclosure. The present disclosure may, however, be embodied in many different forms and should not be construed as being limited to the embodiments set forth herein. Rather, these embodiments are provided so that this disclosure will be thorough and complete, and will fully convey the concept of the present disclosure to those of ordinary skill in the art.

In the description of the present disclosure, if it is determined that a detailed description of related art of the present disclosure unnecessarily obscures the subject matter of the present disclosure, the detailed description will be omitted. Also, since later-described terms are defined in consideration of functions of the present disclosure, they may vary according to users' intentions or practice. Hence, the terms must be interpreted based on the content of the entire specification.

Prior to the detailed description of exemplary embodiments of the present disclosure, terms used herein are defined. The term “read” is sequence data of short length output from a genome sequencer. In general, the length of a read varies from about 35 base pairs (bps) to about 500 bps according to the type of sequencers. Deoxyribonucleic acid (DNA) bases are generally expressed by the letters A, C, G, and T.

The term “reference sequence” denotes a comparative sequence used to generate a whole sequence from reads. In a sequence analysis, by mapping a large number of reads output from a genome sequencer to a reference sequence, a whole sequence is completed. In the present disclosure, a reference sequence may be a genome sequence that has been previously set (e.g., the whole genome sequence of human) upon a sequence analysis, or a sequence generated by a genome sequencer.

The term “base” is the minimum unit constituting a reference sequence and a read. As mentioned above, DNA bases may consist of the four letters A, C, G, and T, each of which is expressed as a base. In other words, DNA bases are expressed by the four bases, which is the same for a read. However, in the case of a reference sequence, it may be unclear which base of A, C, G and T will be expressed at a specific position for various reasons (a sequencing error, a sample error, etc.). In general, such an unclear base is expressed by an additional letter, such as N.

The term “seed” is a sequence that becomes a unit for comparing a read with a reference sequence so that the read may be mapped. Theoretically, in order to map a read to a reference sequence, it is necessary to calculate a mapping position of a read by sequentially comparing the whole read with the reference sequence beginning with a first portion of the reference sequence. However, this method requires too much time and computing power for mapping of one read. Therefore, in practice, candidate mapping positions of a whole read are detected first by mapping a seed, which is a fragment consisting of a portion of the read, to the reference sequence, and then the whole read is mapped (global alignment) to the candidate mapping positions.

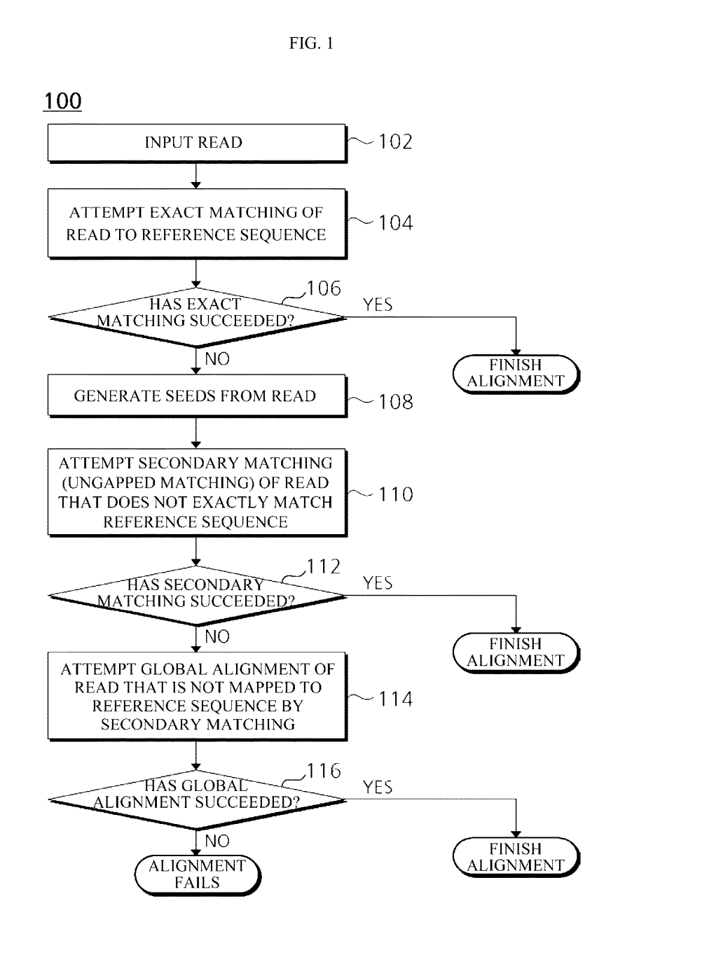

FIG. 1 is a flowchart illustrating a method for sequence alignment according to an exemplary embodiment of the present disclosure. A sequence alignment method 100 denotes a process of comparing a read output from a genome sequencer with a reference sequence to determine a mapping (or alignment) position of the read in the reference sequence. As illustrated in the drawing, the sequence alignment method 100 according to an exemplary embodiment of the present disclosure is generally divided into three steps, which include an exact matching step for a whole read, a secondary matching step for a read that does not exactly match a reference sequence in the exact matching step, and a global alignment operation step for a remaining read that that does not match the reference sequence in the secondary matching step.

First when a read is input from a genome sequencer (102), exact matching is attempted between the whole read and a reference sequence (104). When the exact matching of the whole read succeeds in step 104, subsequent alignment steps are not performed, and it is determined that alignment has succeeded (106). A result of an experiment on human sequences indicates that, when exact matching of 1,000,000 reads output from a genome sequencer to human sequences was attempted, 231,564 instances of exact matching occurred in a total of 2,000,000 alignments (1,000,000 alignments with a forward sequence, and 1,000,000 alignments with a reverse complement sequence). Therefore, as a result of step 104, it was possible to reduce the cost of alignment by about 11.6%.

On the other hand, when it is determined in step 106 that the read does not exactly match the reference sequence, that is, when there is no area exactly matching the read in the reference sequence, a plurality of seeds are generated from the read (108), and secondary matching of mapping the read to the reference sequence is attempted in consideration of mismatches between the read and the reference sequence at mapping positions of the seeds in the reference sequence (110). When a result of the secondary matching in step 110 indicates that one or more mapping positions satisfy a secondary matching condition, one of the mapping positions is selected as the mapping position of the read (112). In other words, in this case, the secondary matching has succeeded. On the other hand, when no mapping position satisfies the secondary matching condition, global alignment operation of the read with the reference sequence is performed last at the mapping positions of the seeds in the reference sequence (114). At this time, if a result of the global alignment operation indicates that the number of errors of the read exceeds a previously set maximum error tolerance MaxError, it is determined that the global alignment operation has failed, and if under MaxError, it is determined that the global alignment operation has succeeded (116).

Although not shown in the drawing, according to an exemplary embodiment, it is possible to add a step of estimating the number of errors that may occur when the read is aligned with the reference sequence before the secondary matching of the read if it is determined in step 106 that the read does not exactly match the reference sequence.

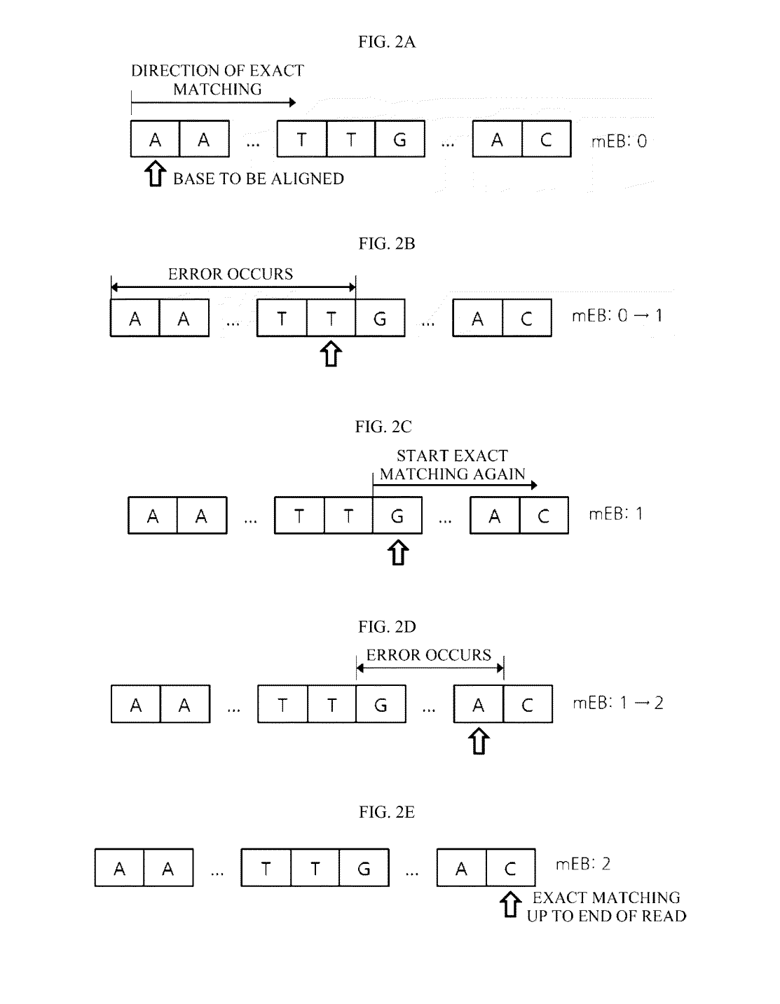

In an exemplary embodiment of the present disclosure, the number of errors may be estimated by calculating a minimum Error Bound (mEB) of errors that may occur when the read is aligned with the reference sequence. FIG. 2 shows diagrams exemplifying an mEB calculation process. First, as shown in (a) of FIG. 2, an initial mEB is set to 0, and exact matching is attempted while shifting from a first base of a read to an end of the read by one base at a time. At this time, as shown in (b), it is assumed that no more exact matching is possible at a specific base of the read (indicated by an arrow in the drawing). This case denotes that an error has occurred somewhere between a matching start position and the current position. Therefore, in this case, mEB is increased by 1, and exact matching is restarted at the next position (shown in (c)). Subsequently, when it is determined again that exact matching is impossible at a specific base, an error has occurred again somewhere between the restart position and the current position. Therefore, mEB is increased again by 1, and exact matching is restarted at the next position (shown in (d)). An mEB of a case where exact matching is attempted up to the end of the read through this process, that is, a case shown in (e) of the drawing, becomes the minimum value of the number of errors that may exist in the read.

When an mEB of the read is calculated through the above-described process, it is determined whether or not the calculated mEB exceeds the previously set maximum error tolerance MaxError. When the calculated mEB exceeds the previously set maximum error tolerance MaxError, it is determined that alignment of the read has failed, and the alignment is finished. In the above-described experiment on human sequences, a result of calculating mEBs of remaining reads when the maximum error tolerance MaxError was set to 3 indicates that the mEBs of the remaining reads exceeded the maximum error tolerance MaxError a total of 844,891 times. In other words, it was possible to reduce the cost of alignment by about 42.2%. On the other hand, when it is determined that the calculated mEB equals the maximum error tolerance MaxError or less, the above-described steps subsequent to step 108 are performed in sequence.

The process of steps 108 to 116 will be described in detail below.

Generation of Plurality of Seeds from Read

In this step, to perform alignment of a read, seeds that are a plurality of small fragments are generated from the read. In this step, a plurality of seeds are generated in consideration of a portion or the whole of a read.

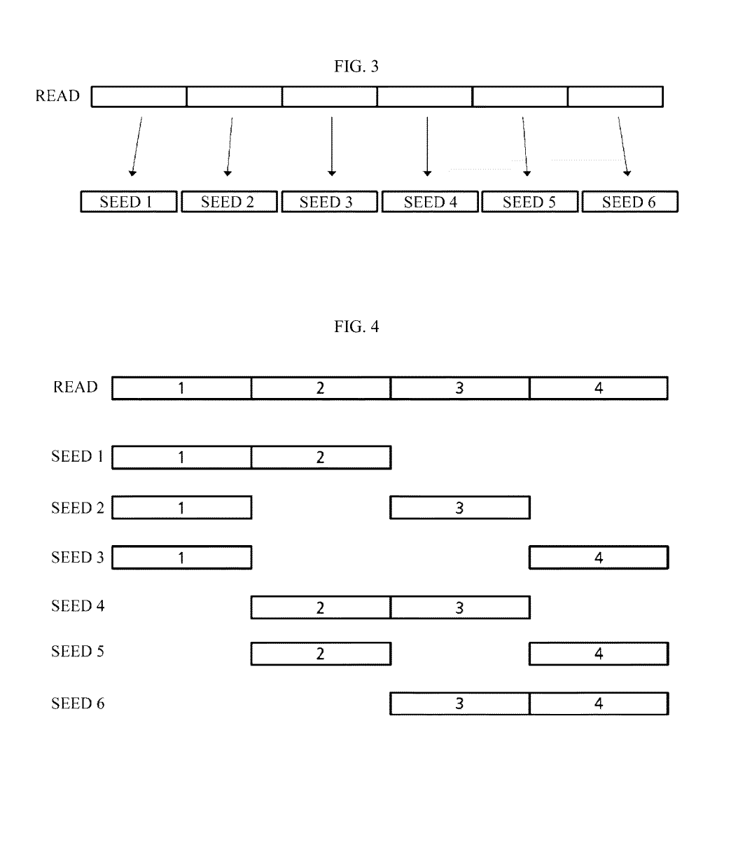

FIGS. 3 to 5 are diagrams exemplifying a seed generation method in which entire sections of a read is taken into consideration. However, seed generation methods described herein are merely examples, and the present disclosure is not limited to a specific seed generation process. For example, seeds may be generated by dividing the whole or a specific section of a read into a plurality of fragments, or by combining divided fragments. In this case, the generated seeds may be continuously connected with each other, but are not necessarily so. Combinations of fragments away from each other in a read may also constitute seeds. Seeds generated from one read need not have the same length, and it is possible to generate seeds having various lengths from one read. In brief, there is no particular limitation on a method of generating seeds from a read in exemplary embodiments of the present disclosure, and a variety of algorithms for extracting seeds from a portion or the whole of a read may be used without limitation.

First, FIG. 3 is a diagram exemplifying a seed generation process according to an exemplary embodiment of the present disclosure. As shown in the drawing, in this exemplary embodiment, seeds may be generated by dividing a whole read into fragments of a set size. In other words, each of the fragments obtained by dividing the read into portions of the same length may be a seed in exemplary embodiments of the present disclosure. The drawing shows an example of a read divided into six fragments. However, the number of fragments and the length of each fragment are not limited, and may be appropriately adjusted for the type of a reference sequence, the length of the read, a maximum error tolerance of the read, and so on. In addition, in the example of the drawing, the read is divided into fragments that do not overlap each other, but may also be divided into fragments that partially overlap each other.

FIG. 4 is a diagram exemplifying a seed generation process according to another exemplary embodiment of the present disclosure. As shown in the drawing, in this exemplary embodiment, seeds may be generated by dividing a whole read into fragments of a set size and then combining two or more fragments among the divided fragments of the read. For example, as shown in the drawing, the read is divided into four fragments (first to fourth fragments), and two each of the four fragments are combined, so that a total of six seeds may be generated. Like in the above-described exemplary embodiment, the number of divided fragments, the length of each fragment, the number of combined fragments, etc. are not limited, and may be appropriately adjusted for the type of a reference sequence, the length of the read, a maximum error tolerance of the read, and so on.

FIG. 5 is a diagram exemplifying a seed generation process according to another exemplary embodiment of the present disclosure. In this exemplary embodiment, seeds are generated by reading values of portions of a read as large as a set size while shifting by a set distance from a first base of the read. In the shown exemplary embodiment, the length of a read is 75 bps, the maximum error tolerance of a read is 3 bps, the size of a seed (fragment size) is 15 bps, and the shift distance (shift size) is 4 bps. In other words, seeds are generated while shifting from a first base of the read to the right by 4 bps at a time. However, the shown exemplary embodiment is merely an example. For example, the shift distance, the size of a seed, etc. may be appropriately set for the length of the read, the maximum error tolerance of the read, and so on. In other words, it is noted that the present disclosure is not limited to a specific seed size or shift distance.

Meanwhile, in exemplary embodiments of the present disclosure, the length of a seed is not limited as mentioned above, but may be determined to be 20% to 30% of the read length. In general, as the length of a seed decreases, the number of times of mapping the seed to a reference sequence increases, and as the length of a seed increases, the number of times of mapping the seed to a reference sequence decreases. When the length of a seed is set to 20% or less of the length of a read that is generally generated by a genome sequencer, the number of times of mapping the seed to a reference sequence excessively increases, and the number of global alignments unnecessarily increases in a subsequent global alignment process. On the other hand, when the length of a seed is 30% or more of the length of a read, the number of times of mapping the seed to a reference sequence excessively decreases, and the accuracy of mapping lowers. Therefore, in exemplary embodiments of the present disclosure, the length of a seed is set to 20% to 30% of the length of a read, and thus it is possible to ensure the quality of mapping and also to minimize complexity that may result from mapping.

In addition, when a reference sequence is a human genome sequence, a seed may be generated to have a length of 15 bps to 30 bps. As mentioned above, when the length of a seed decreases, the number of times of mapping the seed to a reference sequence increases, and when the length of a seed increases, the number of times of mapping the seed to a reference sequence decreases. In particular, when the length of a seed is 14 bps or less in the case of a human genome sequence, the number of mapping positions in the reference sequence drastically increases. Table 1 below shows the average appearance frequency of a seed in a human genome sequence according to seed length.

TABLE 1

| Length of Seed | Average Appearance Frequency |
|---|---|
| 10 | 2,726.1919 |
| 11 | 681.9731 |
| 12 | 170.9185 |
| 13 | 42.7099 |
| 14 | 10.6470 |
| 15 | 2.6617 |
| 16 | 0.6654 |
| 17 | 0.1664 |

As seen from Table 1 above, when the length of a seed is 14 bps or less, the frequency of the seed is 10 or more, but when the length is 15 bps, the frequency is reduced to 3 or less. In other words, when the length of a seed is set to 15 bps or more, it is possible to remarkably reduce the number of times of appearance of the seed compared to a case where the length is set to 14 or less. Also, when the length of a seed is 30 or more, the number of times of mapping of the seed to a reference sequence is excessively reduced, and thus the accuracy of mapping lowers. Therefore, when a reference sequence is a human sequence, the length of a seed is set to 15 bps to 30 bps in the present disclosure so that the quality of mapping may be ensured and also complexity which may result from mapping may be minimized.

Attempt of Secondary Mapping of Read and Determination of Mapping Position

After seeds are generated from a read as described above, each of the generated seeds is mapped to a reference sequence, and then secondary matching of the read is performed at each of the mapping positions of the seeds.

In exemplary embodiments of the present disclosure, secondary matching of a read denotes a process of generating seeds from the read, calculating mismatches of the read by comparing a remaining section of the read with a reference sequence at each of the mapping positions of the seeds in the reference sequence, and determining the mapping position of the read in the reference sequence according to the calculated mismatches and a previously set secondary matching condition. Here, the corresponding read is the read that has been determined not to exactly match the reference sequence as a result of step 104, one or more mismatches occur when the read is compared with the reference sequence at the mapping positions of the seeds. Accordingly, in exemplary embodiments of the present disclosure, one of the mapping positions of the seeds is determined as the mapping position of the read by using mismatches that occur when the read is mapped to each of the mapping positions of the seeds generated from the read. In other words, in exemplary embodiments of the present disclosure, secondary matching is an alignment method (ungapped alignment) in which a gap that may occur in the read is not taken into consideration but only mismatches of the read are taken into consideration.

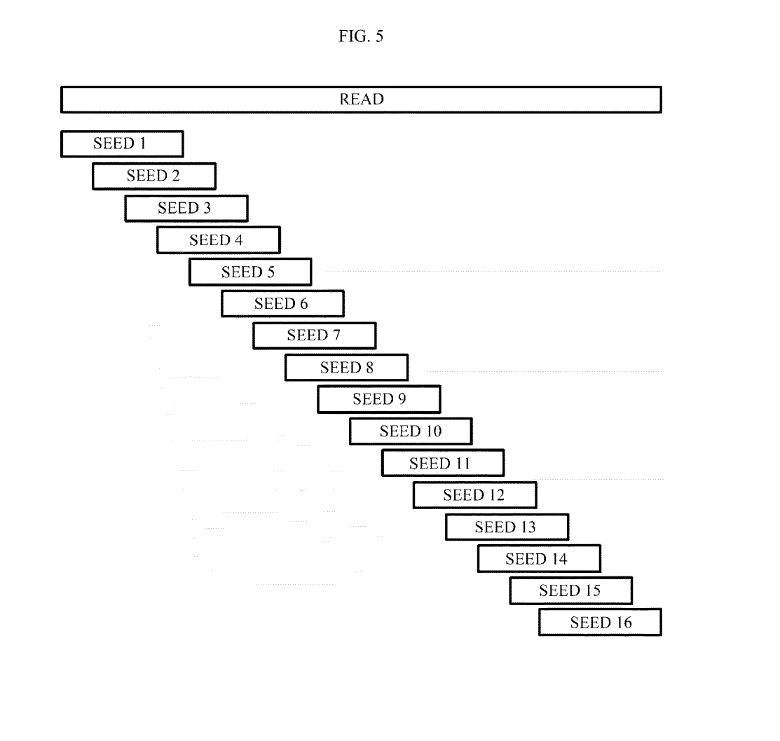

FIG. 6 is a diagram exemplifying mismatches of a case of attempting exact matching of a read to a reference sequence according to an exemplary embodiment of the present disclosure. The drawing shows an example in which exact matching of a read having a length of 12 bps to a reference sequence is attempted, and the initial 4 bps of the read are assumed to be a seed. In the case of the read shown in FIG. 6, the first five bases exactly match the reference sequence, but the sixth, seventh, and tenth bases do not exactly match the reference sequence. In other words, in the example shown, the number of mismatches of the read is 3 at the corresponding mapping position.

In exemplary embodiments of the present disclosure, mismatches of a read may be taken into consideration in various ways. In an exemplary embodiment, step 110 may be configured so that exact matching of the read to the reference sequence is attempted at each of the mapping positions of the seeds, and the number of mismatches occurring in this process is counted. In this case, the secondary matching condition for determining the mapping position of the read may be the number of mismatches. For example, a position resulting in the minimum number of mismatches among the mapping positions of the seeds may be the mapping position of the read. When the secondary matching condition is set in consideration of the number of mismatches in this way, it is possible to map the read to a position that results in the minimum arithmetic error.

In another exemplary embodiment, step 110 may be configured so that quality scores (QSs) of mismatches according to the mapping positions of the seeds are taken into consideration. In other words, in step 110, the sum of QSs at positions at which mismatches occur may be calculated, and a position resulting in the minimum sum of QSs may be determined as the mapping position of the read. In this case, the secondary matching condition may be the QSs of mismatches. A QS of a read is obtained by converting an error probability of each base constituting a read output from a genome sequencer into a score value. A QS of a read may be calculated using various methods, and, for example, the Phred quality score, etc. may be used. However, the present disclosure is not limited to a specific QS calculation method. Details of the QS are well known to those of ordinary skill in the art, and the detailed description thereof will be omitted.

In general, a position having a low QS in a read denotes a position having a high probability of error occurrence. In other words, the smaller the sum of QSs of mismatches at a position, the higher the probability that the read will be mapped to the position. Therefore, according to this exemplary embodiment, it is highly likely to map a read to an accurate position.

Meanwhile, in another exemplary embodiment, step 110 may be configured so that the number of mismatches according to the mapping positions of the seeds and QSs of mismatches are taken into consideration together. In this case, in step 110, positions resulting in the number of mismatches equal to or smaller than a set value are selected from among the mapping positions of the seeds, and then a position resulting in the minimum sum of QSs among the selected positions may be determined as the mapping position of the read.

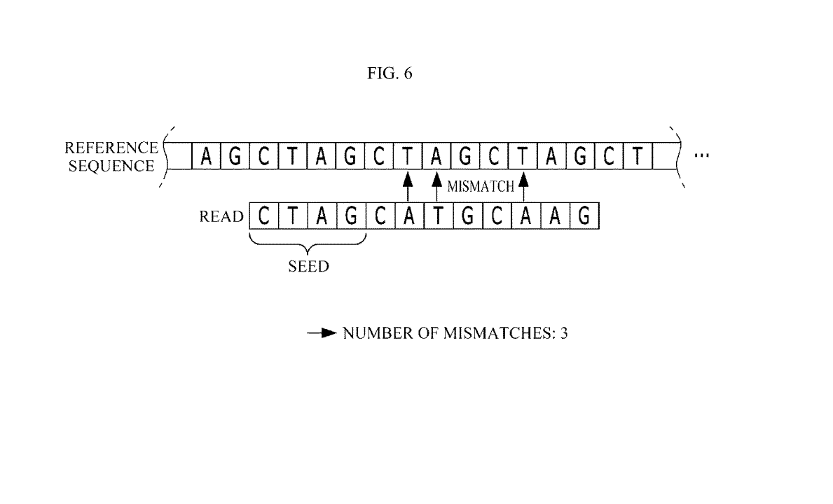

FIG. 7 is a diagram exemplifying a secondary matching process according to an exemplary embodiment of the present disclosure. For example, it is assumed that a specific seed is mapped to each of positions A, B, and C in the reference sequence, and the number of mismatches of the read and the sum of QSs of mismatches at the corresponding position are as shown in the drawing. When the secondary matching condition is set to a position resulting in the minimum sum of QSs of mismatches among positions resulting in five or less mismatches, position A satisfies the secondary matching condition, and thus it is determined that the read is mapped to position A of the reference sequence.

Global Alignment of Read

In the secondary matching step, no mapping position may satisfy the secondary matching condition. In this case, like a general read mapping method, global alignment operation of the read with the reference sequence is performed at each of the mapping positions of the seeds, so that the read is mapped to the reference sequence. In exemplary embodiments of the present disclosure, global alignment operation is an alignment method in which not only mismatches of a read but also gaps are taken into consideration. For example, the Smith-Waterman algorithm, the Needleman-Wunsch algorithm, etc. may be used, but exemplary embodiments of the present disclosure are not limited to a specific algorithm.

In an exemplary embodiment, in the global alignment operation step, global alignment operation may be sequentially performed beginning at a mapping position resulting in the minimum sum of QSs of mismatches among the mapping positions of the seeds. This is because the smaller the sum of QSs of mismatches at a position, the higher the probability that the read will be mapped to the position.

Also, the sequence of the global alignment operation may be determined in consideration of gaps occurring upon matching the read to the reference sequence together with mismatches. For example, in the global alignment operation step, global alignment operation may be sequentially performed beginning at a mapping position resulting in the minimum sum of the number of mismatches and the number of gaps equal to or smaller than a set value among the mapping positions of the seeds. Alternatively, in the global alignment operation step, global alignment operation may be sequentially performed beginning at a mapping position resulting in the sum of the number of mismatches and the number of gaps equal to or smaller than a set value and the minimum sum of QSs of the read at positions of the mismatches and the gaps among the mapping positions of the seeds.

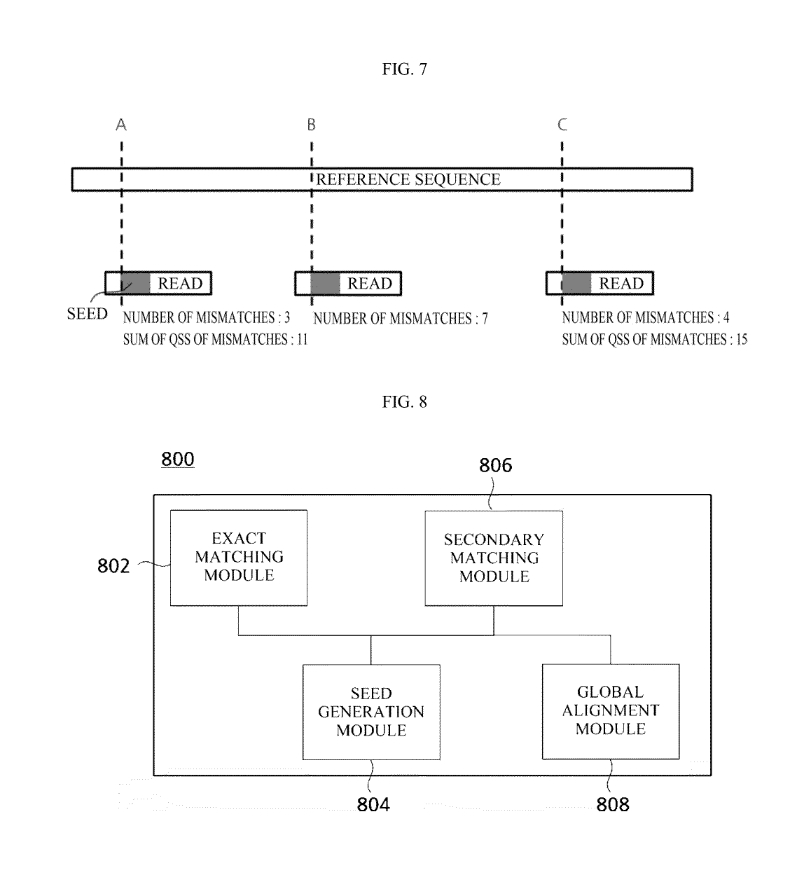

FIG. 8 is a block diagram of a system for sequence alignment according to an exemplary embodiment of the present disclosure. As shown in the drawing, a system 800 for sequence alignment according to an exemplary embodiment of the present disclosure includes an exact matching module 802, a seed generation module 804, a secondary matching module 806, and a global alignment module 808.

The exact matching module 802 performs exact matching of an input read to a reference sequence.

The seed generation module 804 generates a plurality of seeds from the read when the read is not exactly matched to the reference sequence by the exact matching module 802. A detailed seed generation method of the seed generation module 804 has been described above.

The secondary matching module 806 maps the read to the reference sequence in consideration of mismatches between the read and the reference sequence when the read does not exactly match the reference sequence. The secondary matching module 806 may calculate the mapping positions of the generated seeds in the reference sequence, and determine the mapping position of the read in the reference sequence in consideration of mismatches occurring when exact matching of the read to the reference sequence is attempted at each of the mapping positions of the seeds.

In an exemplary embodiment, the secondary matching module 806 may determine a position resulting in the minimum number of mismatches among the mapping positions of the seeds as the mapping position of the read. Alternatively, the secondary matching module 806 may determine a position resulting in the minimum sum of QSs of mismatches among the mapping positions of the seeds as the mapping position of the read, or may determine a position resulting in the number of mismatches equal to or smaller than a set value and the minimum sum of QSs of mismatches among the mapping positions of the seeds as the mapping position of the read.

The global alignment module 808 performs global alignment operation of the read with the reference sequence when the read is not mapped by the secondary matching module 806. As described above, the global alignment module 808 may perform global alignment operation of the read with the reference sequence at each of the mapping positions of the seeds, and in this case, may sequentially perform the global alignment operation beginning at a mapping position resulting in the minimum sum of QSs of mismatches among the mapping positions of the seeds. In this case, as mentioned above, the global alignment operation may be performed in consideration of only mapping positions resulting in the sum of the number of gaps and the number of mismatches equal to or smaller than a set value.

In Table 2 below, a method for sequence alignment according to exemplary embodiments of the present disclosure is compared with related art, that is, a case of performing global alignment operation only, and thus it is possible to see effects of the present disclosure. For comparison, mapping times, mapping rates, and error probabilities were calculated when 1,000,000 reads each having a length of 75 bps are aligned with a reference sequence.

TABLE 2

| Index | Related Art | Present disclosure |
|---|---|---|
| Mapping Time | 00:58:52 | 00:07:57 |
| Mapping Rate | 91.11% | 93.52% |
| Error Probability | 3.89% | 3.90% |

As seen from Table 2 above, when the present disclosure is applied, a mapping time was remarkably reduced from 58 minutes 52 seconds of the related art to 7 minutes 57 seconds. This is because, according to exemplary embodiments of the present disclosure, it is possible to determine the mapping positions of a considerable number of reads in the exact matching step and the secondary matching step before the global alignment operation step. In other words, according to exemplary embodiments of the present disclosure, the number of time-consuming global alignments is reduced, so that the speed of sequence alignment may be increased.

In addition, in terms of mapping rate and error probability, the present disclosure has a slightly improved value and a similar value, respectively, when compared to the related art. In other words, from the comparative experiment results, it is possible to see that mapping speed may be increased while the quality of mapping is maintained according to exemplary embodiments of the present disclosure.

Meanwhile, exemplary embodiments of the present disclosure may include a computer-readable recording medium including a program for performing the methods described herein on a computer. The computer-readable recording medium may separately include program commands, local data files, local data structures, etc. or include a combination of them. The medium may be specially designed and configured for the present disclosure, or known and available to those of ordinary skill in the field of computer software. Examples of the computer-readable recording medium include magnetic media, such as a hard disk, a floppy disk, and a magnetic tape, optical recording media, such as a CD-ROM and a DVD, magneto-optical media, such as a floptical disk, and hardware devices, such as a ROM, a RAM, and a flash memory, specially configured to store and execute program commands. Examples of the program commands may include high-level language codes executable by a computer using an interpreter, etc. as well as machine language codes made by compilers.

According to exemplary embodiments of the present disclosure, the following processes are performed in stages: exact matching of a whole read generated from a sequencer is attempted first, secondary matching is attempted in consideration of only mismatches when the read does not exactly match a reference sequence, and global alignment operation is selectively performed in consideration of both mismatches and gaps when the read is not mapped to the reference sequence by the secondary matching. Here, the secondary matching is basically an exact matching process, and thus shows notably higher speed than global alignment operation having a complexity of O(N²). In other words, according to exemplary embodiments of the present disclosure, it is possible to filter reads exactly matching a reference sequence and reads having only some mismatches through exact matching and secondary matching processes before global alignment. Therefore, it is possible to effectively increase sequence alignment speed compared to related art in which global alignment operation of a read with a reference sequence is simply and directly performed.

In addition, according to exemplary embodiments of the present disclosure, the mapping position of a read is determined in consideration of the quality scores of mismatches during the secondary matching. Therefore, it is possible to maintain the accuracy of sequence alignment while increasing sequence alignment speed.

It will be apparent to those skilled in the art that various modifications can be made to the above-described exemplary embodiments of the present disclosure without departing from the spirit or scope of the present disclosure. Thus, it is intended that the present disclosure covers all such modifications provided they come within the scope of the appended claims and their equivalents.

What is claimed is:

1. A system for sequence alignment, the system comprising:
an exact matching module configured to perform exact matching of an input read to a reference sequence;
a secondary matching module configured to map the input read to the reference sequence taking into account a number of mismatches between the read and the reference sequence, when the input read does not exactly match the reference sequence; and
a global alignment module configured to perform a global alignment operation of the input read with the reference sequence when the secondary matching module cannot map the input read to the reference sequence;
wherein at least one hardware processor implements the exact matching module, the secondary matching module, and the global alignment module.

2. The system of claim 1, further comprising a seed generation module configured to generate a plurality of seeds from the input read when the input read does not exactly match the reference sequence.

3. The system of claim 2, wherein the seed generation module is further configured to generate the plurality of seeds from entire sections of the input read.

4. The system of claim 2, wherein the seed generation module is further configured to generate the plurality of seeds by reading values of portions, of the input read, the portions each having a respective size as large as a set size, while shifting a read position by a set distance from a position of a first base of the input read.

5. The system of claim 2, wherein the seed generation module is further configured to generate each of the plurality of seeds to have a respective length of 15 base pairs (bps) to 30 bps, inclusive.

6. The system of claim 2, wherein the secondary matching module is further configured to calculate mapping positions of the generated seeds in the reference sequence, and determine a mapping position of the input read, in the reference sequence, taking into account a number of mismatches occurring when exact matching of the input read to the reference sequence is attempted at each said mapping position of each of the seeds.

7. The system of claim 6, wherein the secondary matching module is further configured to determine a position resulting in a minimum number of mismatches among the mapping positions of the seeds as the mapping position of the input read.

8. The system of claim 6, wherein the secondary matching module is further configured to determine a position resulting in a minimum sum of quality scores (QSs) of mismatches among the mapping positions of the seeds as the mapping position of the input read.

9. The system of claim 6, wherein the secondary matching module is further configured to determine a position, as the mapping position among the mapping positions of the seeds of the input read, resulting in a number of mismatches less than or equal to:
a set value, and
a minimum sum of quality scores (QSs) of the mismatches.

10. The system of claim 6, wherein the global alignment module is further configured to perform the global alignment operation, of the input read with the reference sequence, at each of the mapping positions of the seeds.

11. The system of claim 10, wherein the global alignment module is further configured to sequentially perform the global alignment operation beginning at a mapping position resulting in a minimum sum of quality scores (QSs) of mismatches among the mapping positions of the seeds.

12. The system of claim 10, wherein the global alignment module is further configured to sequentially perform the global alignment operation beginning at a mapping position, among the mapping positions of the seeds, resulting in a minimum sum of:
a number of mismatches and
a number of gaps equal to or smaller than a set value.

13. The system of claim 10, wherein the global alignment module is further configured to sequentially perform the global alignment operation beginning at a mapping position, among the mapping positions of the seeds, resulting in a sum of:
a number of mismatches,
a number of gaps equal to or smaller than a set value, and
a minimum sum of quality scores (QSs) of the mismatches and the gaps.

14. A method for sequence alignment, the method comprising:
an exact matching step of performing, with an exact matching module, exact matching of an input read to a reference sequence;
a secondary matching step of mapping, with a secondary matching module, the input read to the reference sequence taking into account a number of mismatches between the input read and the reference sequence, when the input read does not exactly match the reference sequence; and
a global alignment operation step of performing, with a global alignment module, global alignment operation of the input read with the reference sequence when the secondary matching module cannot map the input read to the reference sequence in the secondary matching step;
wherein at least one hardware processor implements the exact matching step, the secondary matching step, and the global alignment operation step.

15. The method of claim 14, further comprising, before the secondary matching step, a seed generation step of generating a plurality of seeds from the input read when the input read does not exactly match the reference sequence.

16. The method of claim 15, wherein the seed generation step includes generating the plurality of seeds from entire sections of the input read.

17. The method of claim 15, wherein the seed generation step includes generating the plurality of seeds by reading values of portions of the input read, the portions each having a respective size as large as a set size, while shifting a read position by a set distance from a position of a first base of the input read.

18. The method of claim 15, wherein the seed generation step includes generating the plurality of seeds to each have a respective length of 15 base pairs (bps) to 30 bps, inclusive.

19. The method of claim 15, wherein the secondary matching step includes:
calculating mapping positions of the generated seeds in the reference sequence; and
determining a mapping position of the input read in the reference sequence, taking into account a number of mismatches occurring when exact matching of the input read to the reference sequence is attempted at each said mapping position of each of the seeds.

20. The method of claim 19, wherein the determination of the mapping position includes determining a position resulting in a minimum number of mismatches among the mapping positions of the seeds as the mapping position of the input read.

21. The method of claim 19, wherein the determination of the mapping position includes determining a position resulting in a minimum sum of quality scores (QSs) of mismatches among the mapping positions of the seeds as the mapping position of the input read.

22. The method of claim 19, wherein the determination of the mapping position includes determining a position, as the mapping position among the mapping positions of the seeds of the input read, resulting in a number of mismatches less than or equal to:
a set value, and
a minimum sum of quality scores (QSs) of the mismatches.

23. The method of claim 19, wherein the global alignment operation step includes performing global alignment operation of the input read with the reference sequence at each of the mapping positions of the seeds.

24. The method of claim 23, wherein the global alignment operation step includes sequentially performing the global alignment operation beginning at a mapping position resulting in a minimum sum of quality scores (QSs) of mismatches among the mapping positions of the seeds.

25. The method of claim 23, wherein the global alignment operation step includes sequentially performing the global alignment operation beginning at a mapping position, among the mapping positions of the seeds, resulting in a minimum sum of:
a number of mismatches, and
a number of gaps equal to or smaller than a set value.

26. The method of claim 23, wherein the global alignment operation step includes sequentially performing the global alignment operation beginning at a mapping position, among the mapping positions of the seeds, resulting in a sum of:
a number of mismatches,
a number of gaps equal to or smaller than a set value, and
a minimum sum of quality scores (QSs) of the mismatches and the gaps.
